(19) United States
(12) Patent Application Publication
(10) Pub. No.: US 2019/0202719 A1
(43) Pub. Date: Jul. 4, 2019

(54) METHOD FOR CONTROLLING MOLLUSK POPULATIONS

(71) Applicants: Joseph Daniel Cook, Athens, AL (US); John Fournier, Ithaca, NY (US)

(72) Inventors: Joseph Daniel Cook, Athens, AL (US); John Fournier, Ithaca, NY (US)

(21) Appl. No.: 16/092,963

(22) PCT Filed: Apr. 11, 2017
(86) PCT No.: PCT/US17/27077

§ 371 Date: Oct. 11, 2018

Related U.S. Application Data
(60) Provisional application No. 62/321,171, filed on Apr. 11, 2016.

(51) Int. Cl. C02F 1/50; A01N 37/36

(52) U.S. Cl. CPC C02F 1/50; C02F 1/66; A01N 37/36

(57) ABSTRACT

A method for controlling mollusk populations is provided. Invasive mollusk populations may colonize lakes, rivers, streams, or other water sources such as commercial or industrial facilities. Mollusk populations may be eliminated or controlled by administering an organic acid solution to a raw water source colonized by mollusks. Organic acids such as lactic acid, citric acid, gluconic acid, or glycolic acid may be utilized. Invasive mollusks may also attach to static surfaces such as marine equipment, boat hulls, or live wells. Attached mollusk or mollusk veligers may be eliminated or controlled by spraying attachment surfaces with an organic acid solution.

### CROSS REFERENCES

This application is a United State National Stage Application of PCT/US 17/27077, filed Apr. 11, 2017, which claims the benefit of U.S. Provisional Application No. 62/321,171, filed on Apr. 11, 2016, which each application is incorporated herein by reference.

### FIELD OF THE INVENTION

The present invention relates generally to a method for controlling invasive mollusk populations.

### BACKGROUND

The taxonomic class “Bivalvia” includes several invasive mollusks, from saltwater and freshwater habitats, like the blue mussel (Mytilus edulis), the Asian clam (Corbicula fluminea), zebra mussels (Dreissena polymorpha), and quagga mussels (Dreissena bugensis). Freshwater zebra mussels (of the dreissenid family) are an invasive species to the United States that inhabits lakes, ponds, rivers, creeks, and canals. The species is native to Eastern Europe and Western Russia and was brought to the Great Lakes region in the ballast water of ships, probably in the 1980s. Populations of zebra mussels have spread rapidly to all of the Great Lakes, clogging intakes from the lakes that provide water for urban water supplies and power plants. By the early 1990s, zebra mussels were found in the St. Lawrence River and many major river systems connected to the Great Lakes watershed via the Chicago Sanitary and Ship Canal, such as the Ohio, the Mississippi, and the Missouri Rivers. Quagga mussels, similar to zebra mussels and also in the dreissenid family, have also been found in all of the Great Lakes and have become the predominant invasive species.

Both species have been found throughout the midwestern United States and also west of the Continental Divide. Dreissenid mussels have likely spread to these areas via overland boat hauling. Keeping watercraft and all vehicles and trailers transporting such watercraft free of adult mussels and mussel larvae (or veligers) is a priority for western states that are trying to control the spread of dreissenids. For this reason, many states have mandatory, state-certified boat inspection programs to help prevent the spread of dreissenid mussels. Watercraft that have been in infested waters are required to be decontaminated and/or quarantined for periods of time.

In addition to colonizing natural water bodies, zebra and quagga dreissenid mussels have also become a serious problem for various types of industrial facilities and associated conduits for transporting water, such as water circulation systems, canals, ditches, irrigation systems, or other man-made structures or piping systems for moving water. For instance, irrigation systems, such as those used for golf courses, are highly susceptible to infestation, since water intakes and pipe networks are ideal habitats for dreissenid mussels. The invasive mussels can clog water inlets, outlets, pipes, and pumps. The presence of mussels in equipment may lead to loss of intake head on pumping systems and obstruct water flow. The mussels may also cause pitting, thereby increasing corrosion of pipes, valves, sprinklers, pumps, and other equipment. All irrigation system parts may be subject to colonization. In addition, the mussels harm native species, negatively impact the ecosystem, and can be hazardous to swimmers and recreationalists due to sharp shells.

Zebra and quagga mussels have no preferred colonization sites. Each female produces thousands of larvae, or veligers, which immediately search for a place to attach. Any hard, underwater substrate may provide a suitable attachment surface that can host a mussel colony. Agricultural and golf course irrigation systems, residential water systems, and power plant and industrial cooling systems are all susceptible to mussel colonization. Even systems lacking a hard substrate can be invaded by mussels, which may attach to a variety of surfaces, including soft surfaces or other natural surfaces such as the stalks of reeds or other aquatic plants

Management of invasive mussels is critical for protecting aquatic infrastructure and ecological systems, including the protection of native freshwater mussels, which are in decline due to dreissenids. There are both proactive and reactive methods to remove invasive mussel populations. Reactive removal of colonized adult mussels may be by either physical or chemical methods. Proactive methods for mussel control are any physical or chemical means for preventing the planktonic larval mussels from settling on hard substrates and growing to the adult stage. Proactive methods are often referred to as “settlement prevention”.

Invasive mussels are adapted for life under “normal” ambient conditions and may not survive if their conditions are significantly altered. Non-chemical treatment methods may be utilized to alter environmental conditions. However, the extreme physical conditions that may kill invasive mussels, such as excess heat, excess cold, oxygen deprivation, and irradiation, require that the entire environment be substantially altered.

Chemical treatment is generally the chosen method for dreissenid mussel control, particularly in industrial facilities. A variety of chemical treatment strategies are available for controlling mussel populations. However, since the chemicals that are applied may be discharged directly to rivers, lakes, or other waters, environmental impact must be considered. Chemical molluscicides and their prescribed usage method must be assessed, approved, and registered under the Federal Insecticide, Fungicide, and Rodenticide Act (FIFRA) by U.S. EPA's Office of Pesticide Programs (OPP). Molluscicides used in federal facilities or lands may further trigger the requirement for an Environmental Assessment (EA) under the National Environmental Policy Act (NEPA). Discharge of treated waters or effluents into “Waters of the United States” are further regulated under the “Clean Water Act”, generally requiring a “National Pollutant Discharge Elimination System” (NPDES) permit, and may be subject to approval or assessments of other governmental agencies.

Each treatment site may pose unique problems, and treatments may vary depending on a particular application. Some proprietary compounds for chemical treatment are EPA-registered and commercially available. However, the most widely used chemical treatment for dreissenid mussel control is Sodium Hypochlorite (chlorine bleach). The usage and effects of chlorine in potable water systems is well documented and the treatment is relatively inexpensive. Sodium hypochlorite is a preferred source for chlorine treatment since it is readily available, inexpensive, and easily transported. However, there are a variety of problems associated with chlorine use. Chlorine is non-selective and acutely toxic to other forms of aquatic life. In the United States many local, state, and federal authorities have made the reduction of chlorine, chlorinated effluents, and chlorine by-product discharges to aquatic environments a high priority. Thus, due to environmental regulations limiting chlorine application and discharge concentrations, chlorine treatment may take significantly long periods of time to effectively reduce mussel populations. In addition, chlorine and certain proprietary compounds used for mussel control typically have to be detoxified prior to external release by using substances such as bentonite clay or sulfites.

In addition to the potential for short or long-term negative effects to the ecosystem, the use of chlorine has several significant drawbacks to industry. As a powerful oxidant, it presents an acute risk to workers in the case of accidental spills or releases. It is highly corrosive and significantly reduces the life of storage tanks, pumps, pipes, and other equipment it contacts. These infrastructure costs are rarely captured, so that the overall costs of chlorine treatments are generally understated. In addition, chlorine may dissipate in warm, sunny conditions, thereby requiring multiple chlorine additions at multiple points in a water system.

Where chlorine is used to treat raw water with a high organic load, production of carcinogenic compounds, such as Trihalomethanes (THMs) is common. The use of chlorine to treat a colonized water body providing raw water to a city may result in unacceptable levels of THMs for users of downstream water. In some situations, this may keep a municipality from using the chlorine necessary to disinfect drinking water. Due to the limited selection of EPA-registered products available for controlling mussel populations, the risk of chlorine overuse is always present.

There are other commercially available chemical treatments used for mussel control, including some proprietary compounds. Some examples include potassium salts, copper-based algaecides, Endothall-based algaecides, and inorganic mineral acids. However, like chlorine, other chemical molluscicides known to kill dreissenids cannot readily be isolated to a specific target zone and may be impractical because of toxicity to other aquatic life and persistence in the environment. Thus, the expense of mitigating environmental impact must be considered, as well as the potential effect of the treatment on piping and equipment. For instance, inorganic acids cause significant environmental problems and equipment corrosion, in addition to being expensive to treat a large volume of water. An additional problem is that most chemical molluscicides, including inorganic acids, are not typically effective in cold water, which may limit the geographical locations and the times of year in which they may be used effectively.

Accordingly, there exists a need in the art for an environmentally friendly, efficacious, and inexpensive chemical molluscicide for controlling mollusk populations.

### SUMMARY

In accordance with the present disclosure, a method for controlling mollusk populations is provided. The method utilizes an organic acid solution and is effective in controlling invasive mollusk populations, including bivalves and aquatic and terrestrial gastropods. For example, the method may be used to control populations of aquatic mollusks such as zebra mussels (Dreissena polymorpha), quagga mussels (Dreissena bugensis), blue mussels (Mytilus edulis), Asian clams (Corbicula fluminea), golden mussels (Limnoperna fortune), Mediterranean mussels (Mytilus galloprovincialis), and New Zealand mud snails (Potamopyrgus antipodarum). The method may also be used to control populations of terrestrial mollusks such as apple snails (Ampullariidae), giant African snails (Lissachatina fulica), rosy wolf snails (Euglandina rosea), and other types of invasive snails or slugs.

A raw water source susceptible to invasive mollusk colonization is treated by administering an organic acid solution to the raw water source. The organic acid solution may comprise lactic acid, citric acid, gluconic acid, glycolic acid, or a combination thereof. The raw water source may include natural waterways or man-made water containment or circulation systems, such as irrigation systems or water systems in industrial facilities. Invasive mollusk species, such as zebra and quagga mussels, are known to have a relatively narrow range of pH tolerance, optimally from pH 7.5 to pH 9.3. The organic acid solution is administered to the raw water source in an amount sufficient to lower the pH of the raw water source to 7.4 or lower for a period of time sufficient to kill mollusks and mollusk veligers living therein. The pH of the raw water source is preferably lowered to a range of pH 3.5 to pH 4.5 and maintained within this range during treatment. A higher pH, such as in the range of pH 5.0 to pH 7.0, may be utilized, but the period of time sufficient to kill mollusks may require significantly longer exposure times than required at a lower pH range. A pH lower than 5.0 is preferred.

In order to prevent mollusk veligers from being transported between bodies of water on boat hulls or similar types of equipment having surfaces to which veligers may attach, such surfaces may be treated by applying an organic acid solution to the surface before exposing the surface to a raw water source. This treatment kills mollusks and mollusk veligers attached to the surface and prevents the spread of invasive mollusks via overland hauling to new bodies of water. In addition, populations of terrestrial mollusks, such as invasive snail species, may be controlled by spraying an organic acid solution directly onto individual mollusks. Each mollusk is contacted with a dose of organic acid solution sufficient to kill the mollusk.

Although many chemical and non-chemical treatments for invasive mollusk species have been developed, little consideration has been given to the use of lower pH treatments for mollusk control, possibly because pH values above 7.0 are so widely accepted in the common usage of sodium hypochlorite treatments, and possibly because of the environmental impacts and the generally corrosive effect of inorganic acids on aquatic infrastructure. In addition, little consideration may have been given to organic acids due to the fact that organic acids are relatively weak acids compared to inorganic acids and that organic acids generally are significantly more costly than inorganic acids. However, in accordance with the present disclosure, it has been found that organic acids at a pH of 2 or higher have negligible corrosive effect on aquatic structural materials and are effective in controlling mollusk populations in both warm and cold water.

Samples of organic acids were prepared and tested to examine the efficacy of these acids for mollusk elimination or control. The acids selected were chosen because they are relatively mild and environmentally friendly organic acids. When administered to a raw water source, the organic acids were effective in controlling aquatic mollusk populations in both warm water (>18° C.) and cold water (<12° C.) testing. In both cases the mollusks died off in much shorter periods than expected from previous experience with inorganic acids.

The present invention provides a method for controlling mollusk populations in accordance with the independent claims. Preferred embodiments of the invention are reflected in the dependent claims. The claimed invention can be better understood in view of the embodiments described and illustrated in the present disclosure, viz. in the present specification and drawings. In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the invention per se.

### DESCRIPTION OF THE DRAWINGS

These and other features, aspects, and advantages of the present invention will become better understood with regard to the following description, appended claims, and accompanying drawings where:

FIG. 1 is a graph illustrating a relationship between a treatment duration and a cumulative mortality of mollusks in accordance with the present disclosure.

FIG. 2 is a graph illustrating a relationship between a treatment duration and a cumulative mortality of mollusks in accordance with the present disclosure.

FIG. 3 is a table showing average mollusk veliger mortality with standard deviation for different concentrations of organic acids for different exposure times.

FIG. 4 is a table showing average mollusk veliger mortality with standard deviation for different concentrations of organic acids for different exposure times.

### DETAILED DESCRIPTION

In the Summary above and in this Detailed Description, and the claims below, and in the accompanying drawings, reference is made to particular features, including method steps, of the invention as claimed. In the present disclosure, many features are described as being optional, e.g. through the use of the verb “may” or the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features, or with all three of the three possible features. It is to be understood that the disclosure in this specification includes all possible combinations of such particular features. For example, where a particular feature is disclosed in the context of a particular aspect or embodiment, or a particular claim, that feature can also be used, to the extent possible, in combination with/or in the context of other particular aspects or embodiments, and generally in the invention as claimed.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

A used herein, the term “mollusk” refers to any bivalves (marine or freshwater) or gastropods (aquatic or terrestrial), as well as larval mollusks, also referred to as veligers. As used herein, the term “organic acid” refers to any organic compound that is not derived from an inorganic compound or mineral source and that has acidic properties. As used herein, the term “raw water source” refers to any natural or man-made waterway or any man-made water system susceptible to mollusk colonization. Man-made water systems may include tanks, piping systems, water conduits such as open channels or aqueducts, circulating or non-circulating systems, irrigation systems, or water systems in any commercial or industrial facility, such as power plants or residential water supplies. A raw water source may also include hatcheries and associated transport waters.

In accordance with the present disclosure, a method for controlling mollusk populations is provided. The method utilizes an organic acid solution and is effective in controlling invasive mollusk populations. In accordance with the method, a raw water source is treated by administering an organic acid solution to the raw water source. The raw water source being treated may have an existing invasive mollusk population living therein or may be a water source that is susceptible to colonization by invasive mollusks due to potential exposure. The organic acid solution may comprise lactic acid, citric acid, gluconic acid, glycolic acid, or a combination thereof. Lactic acid may comprise L-lactic acid, D-lactic acid, or a racemic mixture.

Invasive mollusk species, such as zebra and quagga mussels, are known to have a relatively narrow range of pH tolerance, optimally from pH 7.5 to pH 9.3. The organic acid solution is administered to the raw water source in an amount sufficient to lower the pH of the raw water source to 7.4 or lower for a period of time sufficient to kill mollusks living therein. The pH of the raw water source is preferably lowered to a range of pH 3.5 to pH 4.5 and maintained within this range during treatment. A higher pH, such as in the range of pH 5.0 to pH 7.0, may be utilized, but the period of time sufficient to kill mollusks may require significantly longer exposure times than required at a lower pH range. A pH lower than 5.0 is preferred, with a preferred target pH of about 4. The exposure time (duration of treatment) may be extended in order to increase the effectiveness of the treatment, but is preferably long enough to kill at least 25% of a mollusk population living in the raw water source.

The raw water source may be treated in a reactive or a proactive manner. Thus, the method may be used to kill existing adult mollusks living in the raw water source or to prevent mollusk veligers from attaching to substrate or surfaces located in the raw water source in order to prevent colonization. The organic acid solution may be administered into the raw water source in a periodic or a continuous manner. The acid solution may be added into the raw water source in one or more discreet location in order to maximize efficiency.

In order to prevent mollusk veligers from being transported between bodies of water on boat hulls or similar types of equipment having surfaces to which veligers may attach, such surfaces may also be treated by applying an organic acid solution to the surface before exposing the surface to a raw water source. This treatment kills mollusks and mollusk veligers attached to the surface and prevents the spread of invasive mollusks via overland hauling to new bodies of water. In addition, populations of terrestrial mollusks, such as invasive snail species, may be controlled by spraying an organic acid solution directly onto individual mollusks. Each mollusk is contacted with a dose of organic acid solution sufficient to kill the mollusk.

Testing to determine the efficacy of organic acids in controlling aquatic mollusk populations was conducted under carefully maintained conditions. The optimum pH levels to be maintained and the exposure duration necessary for mollusk population control in ambient warm water and cold water conditions were determined through testing, as described below.

### Effective pH Range Determination

To find an optimal pH range at which lactic acid effectively killed adult dreissenid mussels, raw lake water was placed in 4 L water containers and aerated. The pH was adjusted in three containers to about 2.8, 4, and 6, respectively, using lactic acid. The initial water parameters (temperature 20° C., pH 7.6, dissolved oxygen (DO) 7.73, Alkalinity 90 mg/l) were monitored. A fourth container, with no pH adjustment was used for control. Twenty adult mussels of various sizes were placed in each of the three containers. After 24 hours 20% mortality was observed in pH 2.8, 50% mortality at pH 4, and 0% mortality in pH 6 and in the control. Mortality was defined as a gaping shell with the adult mussel not responding to gentle prodding of the flesh. After 48 hours at pH 2.8, shells were disintegrating. There was 100% mortality at pH 4 and no mortality at pH of 6 or in the control. The lower mortality rate at pH 2.8 compared to pH 4 is likely due to mussels detecting a toxic substance in the environment and limiting water intake to avoid the toxic substance.

The experiment was repeated with the pH adjusted to about 5. After 48 hours less than 10% mortality was observed, with no mortality in the control. It was concluded that a pH of about 4 was an effective target pH level for control of dreissenids using lactic acid.

### Comparison of Efficacy of Organic Acids in Warm Water

A second experiment was carried out in the same manner but this time using three different organic acids to adjust lake water to a pH of about 4. The organic acids were lactic acid, gluconic acid, and glycolic acid.

After 24 hours of exposure the observed mortality in lactic acid was just over 10% rather than the 50% observed previously. This discrepancy may have been due to cooler temperature as well as a slightly higher starting pH than in the first experiment. The pH in all treatments increased with time and had to be re-adjusted to a pH of about 4.

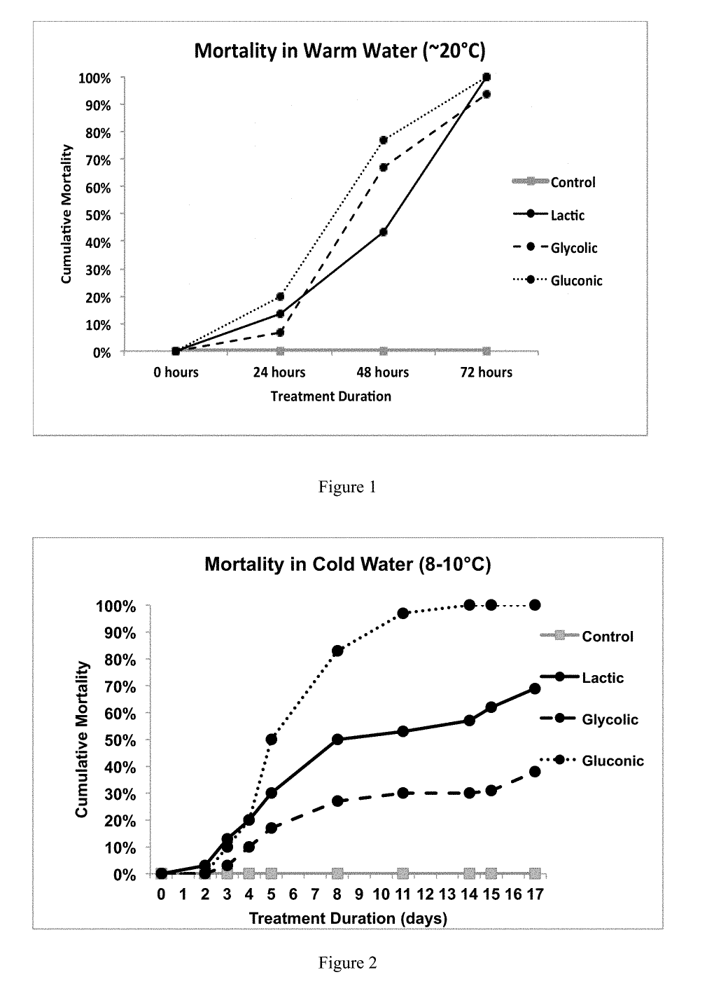

After 48 hours, there was close to 50% mortality observed in the lactic acid group, about 67% mortality in the glycolic acid group, and about 77% mortality in the gluconic acid group, as shown in FIG. 1. After 72 hours, complete mortality was observed in the lactic acid and gluconic acid treatments. The glycolic acid treatment had about 93% mortality. The results are shown in FIG. 1.

Most molluscicides that work well in warm water (>18° C.), including chlorine, polyquaternary ammonium compounds such as ClamTrol®, and copper-based products, do not perform as well at lower temperatures (<12° C.). For instance, as temperature decreases, the required treatment duration with chlorine increases. In an experiment at temperatures of about 11.5° C., it took about 42 days of treatment with about 0.5 mg/l of residual chlorine to achieve 95% mortality.

### Comparison of Efficacy of Organic Acids in Cold Water

A cold water (<12° C.) experiment was carried out in the same manner as described above. The same organic acids were used to adjust lake water to a pH of about 4 under cold water conditions ranging from about 8.1-10.3° C. The organic acids tested were lactic acid, gluconic acid, and glycolic acid. All three organic acids tested produced a significant degree of mortality (greater than 25%) in cold water, as shown in FIG. 2, though the required treatment duration was longer than necessary in warm water. After 8 days of treatment, lactic acid had about 50% mortality, glycolic acid had about 27% mortality, and gluconic acid had about 83% mortality. After two weeks, lactic acid had about 57% mortality, glycolic acid had about 30% mortality, and gluconic acid had 100% mortality. After 17 days, lactic acid had about 69% mortality and glycolic acid had about 38% mortality.

The high degree of mortality observed in the cold-water conditions was unexpected. As expected, longer treatment durations were required for all tested organic acid treatments in the cold-water tests to achieve the same level of efficacy as observed in the warm-water tests. These results indicated that treatment with organic acids will control invasive mussels in half of the time or less than is needed when using chlorine.

### Efficiency in Killing Mollusk Veligers

Further testing was conducted specifically on veligers of quagga mussels collected from Lake Mead and utilizing citric acid and L-lactic acid. Trials were conducted using 2 replicate beakers per test interval at approximately 20° C. Test beakers (100 mL) were seeded with at least 200 veligers per replicate in 10 mL of veliger concentrate and filtered lake water and then dosed with 90 mL of prepared acid concentrate for each of the tested concentrations of lactic acid or citric acid. Stock acid solutions were measured by weight and added to filtered lake water to make the total volume needed. Controls were run concurrently with treatments and used filtered lake water instead of acid to add into the beaker. Exposure times included 1, 5, and 15 minutes, and 1 and 24 hours to assess mortality for the different concentrations of acids.

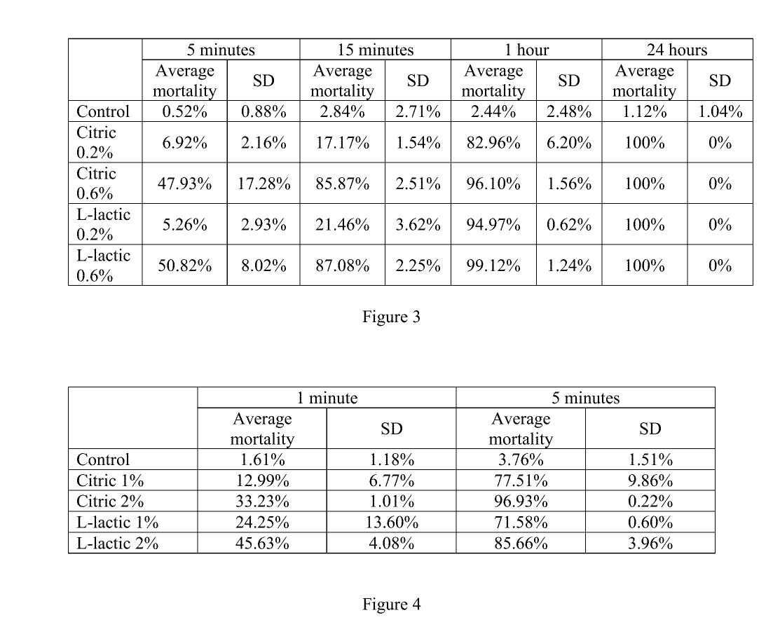

In the first test, the final concentrations of citric acid and L-lactic acid were 0.2% and 0.6% by weight for each acid. The exposure times were 5 minutes, 15 minutes, one hour, and 24 hours. The 0.2% citric acid had a pH of about 2.8, and the 0.2% L-lactic acid had a pH of about 2.9. The 0.6% citric acid had a pH of about 2.4, and the 0.6% L-lactic acid had a pH of about 2.47. Mortality greater than control mortality was achieved in all exposures. L-lactic acid at 0.6% concentration after one hour exposure time had 99% mortality, and citric acid had 96% mortality. Both trials had low standard deviation, which indicated that the acids were working consistently. 100% mortality was observed after a 24 hour exposure time. The results are summarized in FIG. 3, which shows average veliger mortality with standard deviation (SD) for each treatment at each exposure time.

In the second test, the final concentrations of citric acid and L-lactic acid were 1% and 2% by weight for each acid. The exposure times were one minute and 5 minutes. The 1% citric acid had a pH of about 2.2, and the 1% L-lactic acid had a pH of about 2.26. The 2% citric acid had a pH of about 1.98, and the 2% L-lactic acid had a pH of about 2.05. Mortality greater than control mortality was achieved in all exposures, but 100% mortality was not achieved. Citric acid at 2% showed the highest mortality with a five minute exposure time at 97% mortality. L-lactic acid was also effective at the 2% concentration after a five minute exposure time, achieving 86% mortality. The one minute exposure times did produce mortality, but all below 50%. The results are summarized in FIG. 4, which shows average veliger mortality with standard deviation (SD) for each treatment at each exposure time.

Based on the veliger results, citric acid and L-lactic acid may be used to effectively kill mollusk veligers and may be used effectively for boat ballast decontamination.

For a particular mollusk control application, treatment conditions may be adjusted for maximum efficiency. Each particular raw water source to be treated will have specific characteristics, usually alkaline, depending upon indeterminate carbonic/bicarbonate/carbonate, nitrate, and/or phosphate system contents. Thus, calculations of the acid amount required for a target pH value can give an approximation only.

Commercially available organic acids are produced at a process-determined strength, and the maximum strength of a commercially available product may vary for shipping or storage purposes. It has been determined that an organic acid treatment of a raw water source with a target pH value of about 4 preferably implemented by an organic acid solution having a pKa value of less than about 5.0. The pKa values of the tested acids at maximum strength were all approximately 3.5, and somewhat higher as diluted and tested.

For example, to bring a raw water source to a pH of about 4.0 will typically require about 1 ml of about 88% lactic acid to about 4.0 L water (approximately 330 ppm of lactic acid solution by volume), or about 1 ml of 70% glycolic acid to about 4.0 L water (approximately 330 ppmv), or about 5 ml of about 50% gluconic acid to about 4.0 L water (approximately 880 ppmv). Thus, the required concentration of organic acid will generally be less than 2,000 ppmv organic acid solution (0.2%) to adjust a raw water source to a pH of about 4. The raw water source being treated may be a flowing source of water or a still source of water.

A customized plan is preferably utilized for each application or facility where an organic acid treatment protocol is deemed appropriate. Some treatments may be intended to for high efficacy over a short period of time, while other treatments achieve the same mortality over a longer period of time. For instance, when treating boat ballast tanks or isolated systems, environmental concerns for an aquatic environment may not be an issue. In such cases, higher concentrations may be utilized to achieve a desired mortality rate in a short period of time. In addition, veligers generally require a lower concentration than adult mussels. Higher concentrations may also be desired for a high concentration infestation of mollusks. Generally, an increased concentration will reduce the time needed to cause mortality. Alternatively, a longer treatment duration at a lower pH level may be utilized. For instance, a continuous treatment may be utilized throughout a mussel breeding season. Whether or not effluent discharges will be a limitation may also be considered. In addition, the amount of acid added to the system may need to be adjusted to achieve a desired pH level based on the alkalinity of the water being treated. The plan will generally contemplate a number of factors such as the level of infestation and ambient conditions such as water temperature, pH, water volume or flow rate, treatment duration, and restrictions imposed by permitting officials. The plan preferably includes means for evaluation of treatment efficacy. Visual control may apply in some situations, such as treating a power plant fore bay, but when pipes are being treated, a portion of the flow may be directed through a control box containing mussels for mortality confirmation.

In all cases, 100% mortality is preferred. However, this may not be possible, particularly in large, natural water bodies. A minimum mortality of 25% such be achievable using the methods disclosed herein, with a preferred rate of at least 75% mortality.

In treating flowing water for power plants, cooling systems, irrigation systems, and similar systems, an organic acid solution may be metered into the water flow using standard metering pumps and associated equipment. Such equipment will typically already be in place at a facility where sodium hypochlorite has been used for mussel population control. The organic acid concentration will be at a concentration and rate necessary to adjust the flowing raw water acidity to approximate the targeted pH of about 4. Treatment duration will vary according to ambient conditions. Test results indicate that treatment in about 18° C. water or warmer will require only about 48-72 hours for full mortality, and perhaps as long as 14 or more days in 12° C. water.

An additional advantage of the proposed method is that organic acids degrade rapidly under ambient water conditions to nontoxic inert salts, such as calcium lactate or sodium lactate. Therefore, diluted amounts of a residual organic acid, such as lactic acid, discharged downstream from a treatment site, will biodegrade in as little as 24 hours, depending upon water conditions. It is reasonable to expect EPA acceptance of lactic and other organic acids for registration as molluscicides due to the absence of any possible toxicity build-up and the known lack of toxicity to mammals, birds and aquatic organisms. A simple understanding of how the organic acids interact with other environmental factors should be easily explained to NPDES permitting authorities.

An organic acid solution may also be used to treat surfaces that have been or may be exposed to water having bivalve populations living therein. Lactic acid, citric acid, gluconic acid, or glycolic acid may be used. A surface is treated by applying the organic acid solution to the surface before the surface is exposed to a raw water source. This treatment prevents invasive mollusks from spreading from an infested water source to a non-infested source via attachment to boats or other equipment moved between water sources.

For static treatment of surfaces such as marine equipment, marine transport equipment, boat hulls and interiors, live well pumps and piping, interior coolers, marine engine cooling systems, or any other surfaces where mussels may attach, a solution of at least 1% organic acid by weight is preferably utilized, and more preferably a solution of 10% or greater organic acid by weight. Because this treatment occurs away from a water source, the concentration may be increased without affecting the aquatic environment. The solution can be prepared and preferably dispensed by hose or spray. For example, to prevent spread of mussel infestations to new areas via overland transport, surfaces of vehicles, marine transport equipment, and other marine equipment, which may be exposed to a raw water source with mussels living therein, can be sprayed to kill any mussels that may be attached to the surfaces or to prevent spread and attachment to the surfaces before exposing the surfaces to a new raw water source. This method may also be used to prevent the spread of other aquatic invasive pests via overland transport, such as colonial hydroids (Cordylophora caspia), rusty crayfish (Orconectes rusticus), didymo (Didymosphenia geminate), and invasive plants such as hydrilla (Hydrilla verticillata) and Eurasian watermilfoil (Myriophyllum spicatum).

Terrestrial mollusk populations may also be controlled by contacting a mollusk with a dose of an organic acid solution sufficient to kill the mollusk. For instance, invasive snails or slugs may be killed by spraying an organic acid solution, such as lactic acid, citric acid, gluconic acid, or glycolic acid, directly onto individual mollusks.

An experiment was conducted on brown garden snails (Cornu aspersa) and gray garden slugs (Limax maximus) using L-lactic acid and citric acid. Solutions of 1%, 2%, and 4% acid by weight were prepared for L-lactic acid and citric acid. A control solution of water was also prepared. Each solution was sprayed directly onto at least 10 individual mollusks of each species. The 1% solution of both acids resulted in 75% to 91% mortality in both tested species. The 2% solution of both acids resulted in 88% to 100% mortality in both tested species. The 4% solution of both acids resulted in 100% mortality of both species. The control did not cause mortality in any tested individuals. The dosage was calibrated to be about 1.5 ml of acid per individual mollusk. However, each dose was sprayed onto the mollusk so not all of each spray directly contacted each tested mollusk. When using an organic acid spray on mollusks located on plants, it may be preferred to utilize a solution of 0.5% acid in order to minimize phytotoxic damage to plants.

The methods shown and described above are exemplary. Though certain characteristics of the present inventions are described above, the description is illustrative only. It is understood that versions of the invention may come in different forms and embodiments. Additionally, it is understood that one of skill in the art would appreciate these various forms and embodiments as falling within the scope of the invention as disclosed herein.

What is claimed is:

1. A method for controlling mollusk populations, said method comprising the step of treating a raw water source by administering an organic acid solution to the raw water source, wherein the organic acid solution is administered in an amount sufficient to lower the pH of the raw water source to 7.4 or lower for a period of time sufficient to kill at least 25% of a mollusk population living therein.

2. The method of claim 1, wherein the organic acid solution comprises lactic acid, citric acid, gluconic acid, glycolic acid, or a combination thereof.

3. The method of claim 1, wherein the pH of the raw water source is lowered to less than 5.0 for a period of time sufficient to kill at least 25% of a mollusk population living therein.

4. The method of claim 1, wherein the organic acid solution is administered in an amount sufficient to maintain the pH of the raw water source in the range of 3.5 to 4.5 for a period of time sufficient to kill at least 25% of a mollusk population living therein.

5. The method of claim 2, wherein the organic acid solution is administered in an amount sufficient to maintain the pH of the raw water source in the range of 3.5 to 4.5 for a period of time sufficient to kill at least 25% of a mollusk population living therein.

6. The method of claim 1, wherein the pH of the raw water source is lowered for a period of time sufficient to kill at least 75% of a mollusk population living therein.

7. The method of claim 2, wherein the pH of the raw water source is lowered for a period of time sufficient to kill at least 75% of a mollusk population living therein.

8. The method of claim 1, wherein the organic acid solution has a pKa value of less than 5.0.

9. A method for controlling mollusk populations, said method comprising the step of treating a surface by applying an organic acid solution to the surface before the surface is exposed to a raw water source.

10. The method of claim 9, wherein the organic acid solution comprises lactic acid, citric acid, gluconic acid, glycolic acid, or a combination thereof.

11. The method of claim 9, wherein the organic acid solution has an acid concentration of 1% or greater by weight.

12. The method of claim 10, wherein the organic acid solution has an acid concentration of 1% or greater by weight.

13. A method for controlling terrestrial mollusk populations, said method comprising the step of contacting a mollusk with a dose of an organic acid solution sufficient to kill the mollusk.

14. The method of claim 13, wherein the organic acid solution comprises lactic acid, citric acid, gluconic acid, glycolic acid, or a combination thereof.

15. The method of claim 13, wherein the organic acid solution has an acid concentration of 0.5% or greater by weight.

16. The method of claim 14, wherein the organic acid solution has an acid concentration of 0.5% or greater by weight.
